(19) United States
(12) Patent Application Publication
(10) Pub. No.: US 2020/0047571 A1
(43) Pub. Date: Feb. 13, 2020

(54) GROOVE WANDER CALCULATIONS FROM TIRE-ROAD CONTACT DETAILS

(71) Applicant: GM GLOBAL TECHNOLOGY OPERATIONS LLC, Detroit, MI (US)

(72) Inventor: Kenneth L. Oblizajek, Troy, MI (US)

(21) Appl. No.: 16/100,322

(22) Filed: Aug. 10, 2018

(51) Int. Cl. B60C 99/00; G01M 17/02; G06N 5/04

(52) U.S. Cl. CPC B60C 99/006; G06N 5/046; G01M 17/02

(57) ABSTRACT

A computer-program product, system and method for designing a tread pattern for a target tire. A device obtains a footprint of the tire. A predictive equation is created for tire tread spacing from values of scalable parameters related to footprints of a collection of tires. A target tread pattern is evaluated by applying the predictive equation to the target tread pattern. The target tread pattern for the target tire is selected based on the evaluation. The creation of the predictive equation and its use in evaluating the target tread pattern can be performed on a processor.

### INTRODUCTION

The subject disclosure relates to methods for selecting a tire to reduce groove wander and, in particular, to methods of determining a predictive equation that can be used to screen effective tread patterns for a tire with respect to groove wander.

Certain characteristics of tire force generation are related to the transverse positions of tread rib edges along the tire. Groove wander, for example, is the relatively low frequency vibratory experience arising from variations of lateral force of a tire due to the tread ribs of the tire acting against rain grooves and/or contoured deformations in a road's surface. The varying interactive engagement of multiple tread rib edges and rain groove edges results in a lateral dynamic force variation, which produces undesired vibratory motions of the vehicle. This varying engagement occurs as the vehicle encounters various aggregations of rain grooves with the tires as the vehicle moves transversely within a lane or during intentional lane transitions. Since the position of rain groove edges in a road section are not readily changed, the manufacturers generally find it necessary to manipulate the position of the tire tread rib edges to diminish vibrations. Accordingly, it is desirable to provide a system and method for determining a tire tread pattern that is effective in reducing groove wander for a selected road groove pattern.

### SUMMARY

In one exemplary embodiment, a method of designing a tread pattern for a target tire is disclosed. The method includes creating a predictive equation for tire tread spacing from values of scalable parameters related to footprints of a collection of tires, and selecting the tread pattern for the target tire based on an evaluation of the tread pattern determined by applying the predictive equation to the tread pattern for the target tire.

In addition to one or more of the features described herein, the method further includes determining the values of the scalable parameters by substantially minimizing an objective function related to the collection of tires. The objective function is based on differences between calculated groove wander based on the footprints of the collection of tires and measured groove wander obtained by measurement of the collection of tires in use. The calculated groove wander is further based on a road weighting function representative of a severity of impact of a groove spacing on groove wander. The calculated groove wander is based on a multiple road groove response determined from the footprint. The multiple road groove response relates a tire lateral force responsive to a groove spacing in a road section. The scalable parameters include at least one of incremental displacements of tire tread edges, filtering limits to tire tread pattern, a regression offset, and at least one value of a road weighting function.

In another exemplary embodiment, a system for designing a tread pattern for a tire is disclosed. The system includes a device for obtaining a footprint of the tire, and a processor. The processor is configured to create a predictive equation from values of scalable parameters related to footprints of a collection of tires, evaluate a target tread pattern by applying the predictive equation to the target tread pattern, and select the target tread pattern for the target tire based on the evaluation.

In addition to one or more of the features described herein, the processor is further configured to determine the values of the scalable parameters by substantially minimizing an objective function related to a collection of tires. The objective function is based on differences between calculated groove wander based on the footprints of the collection of tires and measured groove wander obtained by measurement of the collection of tires in use. The calculated groove wander is further based on a road weighting function representative of a severity of impact of a groove spacing on groove wander. The calculated groove wander is based on a multiple road groove response determined from the footprint. The multiple road groove response relates a tire lateral force responsive to a groove spacing in a road section. The scalable parameters include at least one of incremental displacements of tire tread edges, filtering limits to tire tread pattern, a regression offset, and at least one value of a road weighting function.

In yet another exemplary embodiment, a computer-program product for designing a tread of a tire is disclosed. The computer program product includes a computer readable storage medium including computer executable instructions. The instructions include creating a predictive equation from values of scalable parameters related to footprints of a collection of tires, evaluating a target tread pattern by applying the predictive equation to the target tread pattern, and selecting the target tread pattern for the target tire based on the evaluation.

In addition to one or more of the features described herein, the computer-readable medium further comprising instructions to determine the values of the scalable parameters by substantially minimizing an objective function related to a collection of tires. The objective function is based on differences between calculated groove wander based on the footprints of the collection of tires and measured groove wander obtained by measurement of the collection of tires in use. The calculated groove wander is based on a multiple road groove response that relates a tire lateral force responsive to a groove spacing in a road section. The scalable parameters include at least one of: incremental displacements of tire tread edges, filtering limits to tire tread pattern, a regression offset and at least one value of a road weighting function.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a tire imaging apparatus for obtaining a digital footprint of a tire;

FIG. 2 shows an illustrative foot print obtained from a tire using the imaging apparatus of FIG. 1;

FIG. 3 shows a flowchart of a method for determining a multiple road groove response for a selected tire footprint;

FIG. 4 shows an individual road groove response for a tire footprint;

FIG. 5 shows an illustrative multiple road groove response for a tire based on its tire footprint;

FIG. 6 shows a graph illustrating a groove space weighting of a road segment; and

FIG. 7 shows a flowchart illustrating a method of selecting a tire tread pattern using the multiple road groove response determined in FIG. 3.

### DETAILED DESCRIPTION

The following description is merely exemplary in nature and is not intended to limit the present disclosure, its application or uses. It should be understood that throughout the drawings, corresponding reference numerals indicate like or corresponding parts and features.

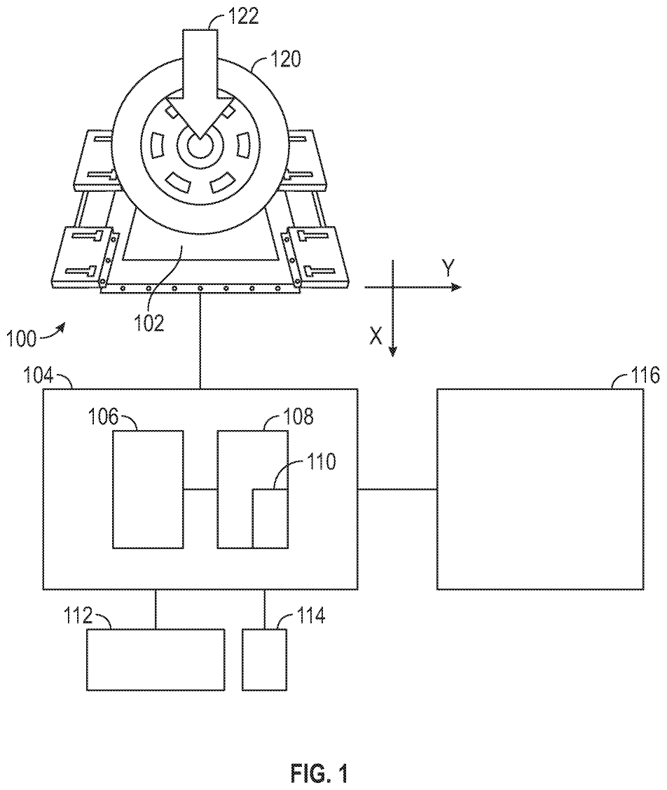

In accordance with an exemplary embodiment, FIG. 1 shows a tire imaging apparatus 100 for obtaining a digital footprint of a tire 120. Other devices for obtaining a tire footprint can also be used in alternate embodiments. The imaging apparatus 100 includes a sensor array 102 and a control unit 104. The sensor array 102 is an N×M array of pixels formed in a two-dimensional plane. For illustrative purposes only, N=M=256. In various embodiments, the resolution of the array is 0.040″×0.040″. Each pixel includes a measurement device or transducer such as, for example a piezoelectric transducer, a resistive transducer, a capacitive transducer or other electrical device that provides a voltage or current in proportion to an amount of force or pressure exerted on the device. The control unit 104 includes a processor 106 in communication with the sensor array 102. The processor 106 receives signals from each of the transducers of the sensor array 102 and provides an image of a footprint of the tire 120 to a display 116 or graphic user interface. In various embodiments, the display 116 is a touchscreen display that allows input to the processor 106 by an operator touching the display 116, thereby allowing the operator to manipulate the image at the display 116. The processor 106 can also store the image to a database or memory location 108. The memory location 108 also stores various programs 110 that, when read by the processor 106, cause the processor 106 to perform methods disclosed herein for determining various parameters of the footprint and using the parameters to determine a tread pattern that is suitable for diminishing the effect of groove wander for at least a section of a road. The processor 106 can also be in communication with various input devices, such as a keyboard 112 and/or a mouse 114. The processor 106 can also provide an output indicating a quality of the tire based on the location of the rib edges.

FIG. 1 also illustrates a method for obtaining a digital footprint of a tire 120. The sensor array 102 is placed so that the plane of the sensor array 102 is horizontal in order to support the tire 120. In an exemplary embodiment, the tire 120 is placed on the sensor array 102 and a static load 122 is applied in a vertical direction in order to press the tire 120 against the sensor array 102. Each pixel of the sensor array 102 provides a signal indicating a force and/or pressure on the pixel by the tire 120. The signal provides a location or position of the pixel and an intensity for the pixel. In an alternate embodiment, the tire 120 can be rolled across the sensor array 102 with a constant downward force applied in order to obtain a footprint.

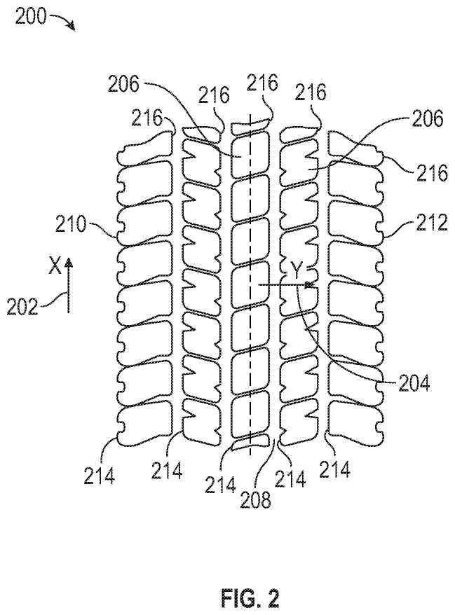

FIG. 2 shows an illustrative foot print 200 obtained from tire 120 using the imaging apparatus 100 of FIG. 1. The foot print 200 is displayed along a selected orientation within a coordinate axis. The coordinate axis includes an x-direction 202 in which the tire rolls and a transverse or y-direction 204 perpendicular to the rolling direction. The y-direction 204 is oriented along a lateral axis of the tire. The tire tread pattern shows an inboard edge 210 that is closer to the body of the vehicle and an outboard edge 212 that is further from the body of the vehicle. A number of rows of tread elements are shown between the inboard edge 210 and the outboard edge 212. The tread rows 206 are separated from each other by recesses or tread grooves 208 in the tire. An edge of the tread row (“tread edge” or “rib edge”) is the location at which the tread row transitions to a recess. Each tread row has a left most edge (indicated by reference number 214) and a right-most edge (indicated by reference number 216). When the tire 100 is used along a road section, the tread elements in the tire will interact with grooves in the road, responsible for the effect of groove wander.

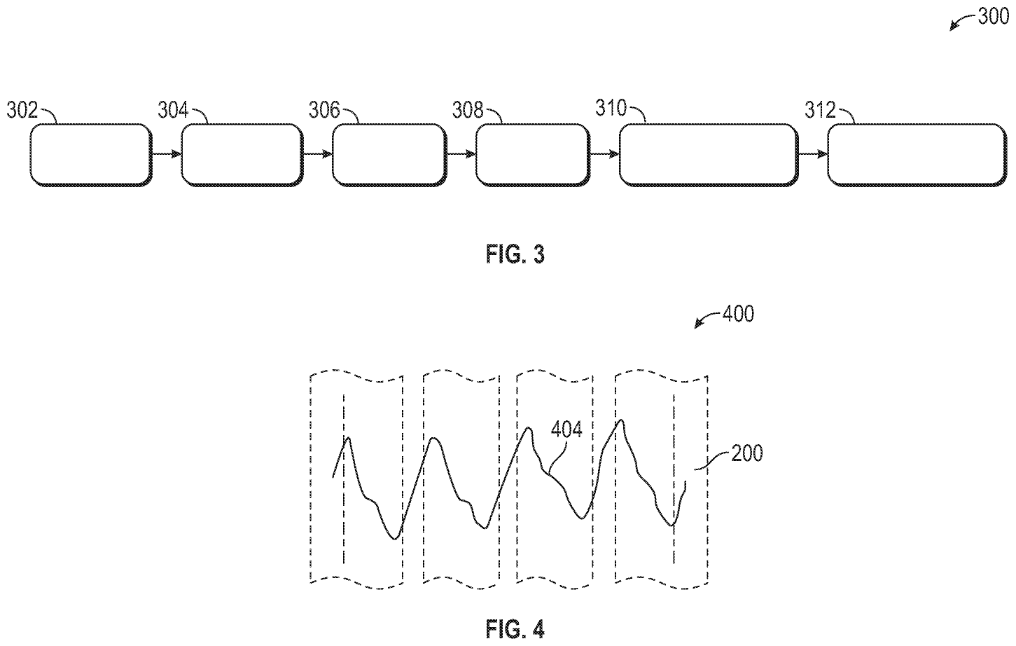

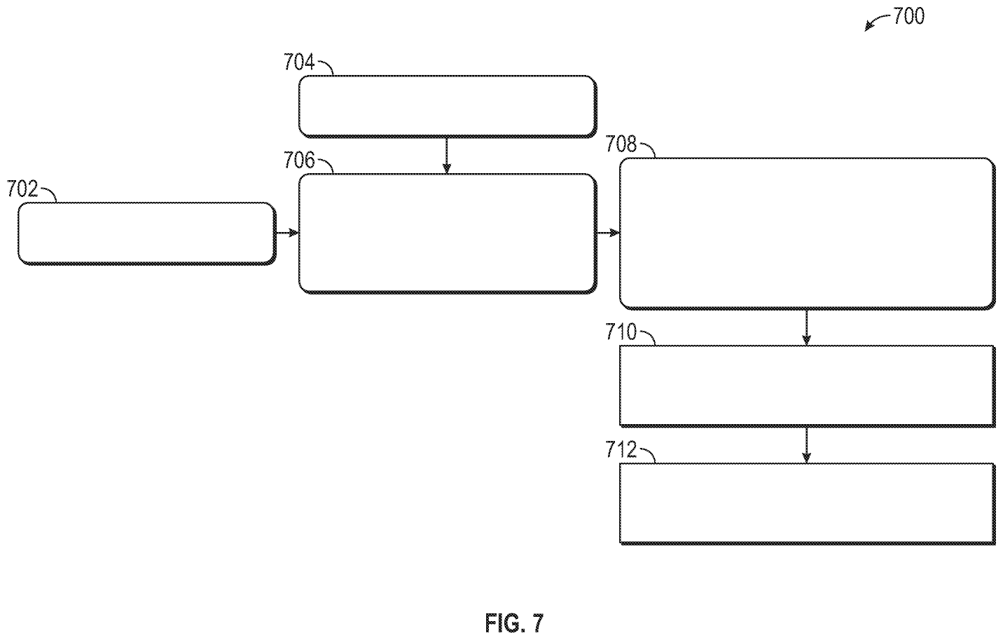

FIG. 3 shows a flowchart of a method 300 for determining a multiple road groove response for a selected tire footprint, such as the footprint 200 of FIG. 2. The multiple road groove response relates an amplitude of a lateral force experienced by the tire to a road groove spacing of a road section. The lateral force is due to interaction of tread row edges of the tire to the road grooves in the road section. In box 302, a footprint 200 for the tire 120 is obtained using, for example, the imaging apparatus 100 of FIG. 1. As discussed below with respect to FIG. 7, the multiple road groove response can be used to calculate groove wander, which can be used to produce a predictive equation for tire tread design.

Referring still to FIG. 3, in box 304 a set of mathematical equations are formulated in order to represent the foot print. The mathematical equations indicate the locations of the rib edges or tread edges of the tire along the y-direction The transverse positions of the edges (primed y-variables below) are expressed against a standard transverse position of the edges (unprimed y-variables below) with an incremental displacement, as shown below in Eqs. (1)-(4):

y_{left,n}′=y_{left,n}+Δ_{ib} Eq. (1)

y_{right,n}′=y_{right,n}−Δ_{ib} Eq. (2)

y_{ob,left}′=y_{ob,left}−Δ_{ob} Eq. (3)

y_{ob,right}′=y_{ob,right}+Δ_{ob} Eq. (4)

where ib refers to the inboard edge of the tire, ob refers to the outboard edge of the tire, left refers to the leftmost edge of an interior tread edge transition, right refers to the rightmost edge of an interior tread edge transition, Δ_{ib} refers to an incremental displacement of interior edges of a tire tread, Δ_{ob} refers to an incremental displacement of outboard edges of a tire tread, and n is an interior edge number. The index n indicates the order or position of the interior tire tread row. Eqs. (1) and (2) represent the locations of the left and right tread rib edges of the n^{th} tread row. Eqs. (3) and (4) represent the locations of the inboard and outboard edge of the tires.

In box 306, a transform is performed on the mathematical representation of the tire tread pattern. The transform creates an impulse function δ(y) at each tread edge. In box 308, a filter is applied to the impulse functions in order to obtain an individual groove response for the tire (in box 310). In various embodiments, the filter applied in box 308 is a butterworth filter or passband filter parameterized by adjustable filter parameters λₗₒ and λₕᵢ. The individual road groove response is therefore obtained in box 310. The individual road groove response is in the form of a function expressing a lateral force on the tread as a function of the transverse distance. In box 312, the individual road groove response is convolved at a road groove spacing to determine a multiple road groove response. The multiple road groove response is the result of the convolving of the individual groove response from box 310 with a function representing a road surface with road grooves separated at groove intervals, wherein the groove interval is a parameter of the road surface function.

FIG. 4 shows a constructed individual road groove response 400 for a tire foot print 200. An outline of the foot print 200 is displayed and the lateral pressure 404 experienced by the tire tread rows along the y-direction is superimposed over the footprint 200.

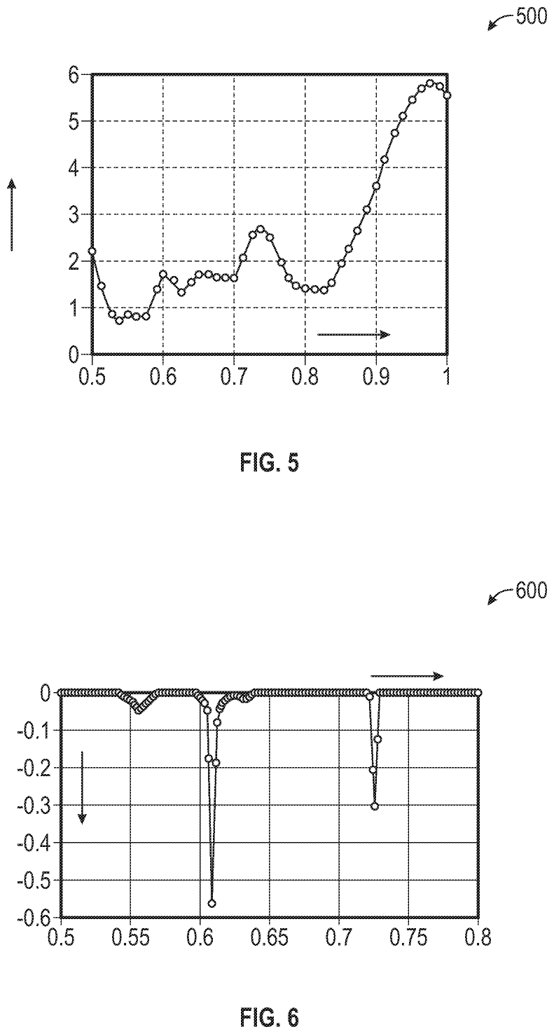

FIG. 5 shows an illustrative multiple road groove response 500 for a tire based on its tire footprint. The response 500 is the peak-to-peak activity, or in other words, the overall excursion of the convolved single road groove response at the respective road groove spacing. The road groove spacing is shown along the abscissa and an amplitude of the constructed lateral force (labelled “yaw excursion”) Hₘ(g) for the tire at the road spacing (g) is shown along the ordinate axis. The index m indicates that multiple groove response for the m^{th} tire of a collection of tires. Thus, a plurality of multiple grooves responses are obtained for a plurality of tires, one for each of m tires.

FIG. 6 shows a graph 600 illustrating a road groove space weighting w(g) of a road segment. The road groove spacing weighting indicates a severity of a road groove spacing or road groove interval on an interaction between the tire and the road. As is evident in graph 600, at many road groove intervals the road may not have a significant impact on the tire. However, at intervals of about 0.55 inches, 0.61 inches and 0.725 inches, there is a significant interaction between road and tire. It is to be understood that these intervals apply only to the road segment of FIG. 6 and are used for illustrative purposes only. Another road segment will have different intervals. The particular intervals that exhibit significant interaction between the road and tire are dependent on the road segment of interest. The road weighting function w(g) is used with the multiple road groove response 500, FIG. 5 in order to calculate a groove wander response (GW) of the tire to the road segment, as discussed below with respect to FIG. 7.

FIG. 7 shows a flowchart illustrating a method 700 of selecting a target tire tread pattern using the multiple road groove response determined in FIG. 3. In box 702, the multiple road groove response Hₘ(g) is obtained. In box 704, a road weighting function w(g) is obtained. The road weighting function w(g) provides weights indicating a severity of impact between tire and road in affecting groove wander based on groove spacing in the road. In box 706, a groove wander function GWₘ is calculated from the multiple road groove response and the road weighting function w(g), as shown in Eq. (5):

GWₘ=Σ_{g}Hₘ(g)∘w(g)+GW₀Eq. (5)

The groove wander function GWₘ for each individual tire, m, is a summation of products of the multiple road groove response, Hₘ(g), and the road weighting function, w(g) at each road groove spacing, g. An offset groove wander response GW₀, common to all tires, is included in the calculation.

In box 708, an objective function is created and minimized or substantially minimized to determine suitable values of scalable parameters that can be used for the selected tire tread patterns. Scalable parameters q include parameters such as incremental displacements Δ_{ib} and Δ_{ob}, passband limit parameters λₗₒ and λₕᵢ, offset groove wander parameter GW₀, and road weighting function w(g), as shown mathematically in the set of Eq. (6):

q={w(q),GW₀,Δ_{ib},Δ_{ob},λₗₒ,λₕᵢ} Eq. (6)

The objective function seeks to minimize a sum of the squares of the difference between the calculated groove wander GWₘ and a measured groove wander GWactₘ. In various embodiments, the measured groove wander GWactₘ is measured by running a vehicle having the m^{th} tire over a road section having the road weighting function w(g). The objective function Obj(q) is shown in Eq. (7):

Obj(q)=Σ(GWₘ−GWactₘ)² Eq. (7)

where the summation is over M tires. The objective function is minimized or substantially minimized via the function of Eq. (8):

$$arg {min}_{q} ( Obj ( q ) ) \qquad Eq . ( 8 )$$

which determines values of the scalable parameters q for which the objective function is a minimum. Thus, by minimizing the objective function, a selected set of the scalable parameter can be found. In box 710, the values of the scalable parameters q that minimize the objective function are used in a predictive equation F(q) that evaluates a tread pattern for a tire either within the original collection of tires used for the development of the parameters or any subsequent target tire using the previously established parameters. In box 712, the predictive equation F(q) is used to determine or design a tread pattern most suitable for a selected road section. Alternatively, the predictive equation F(q) is used to select an existing tire for use over the road section based on the existing tread pattern of the tire. In particular, a candidate or target tread pattern, or its mathematical representation, can be entered into the predictive equation in order to evaluate the suitability of the target tread pattern for a road section. The evaluation can be in the form of a score or result output by the equation. The score or result can be compared to a threshold value in order to determine whether the candidate or target tire pattern is suitable for use on the road section. In various embodiments, after evaluation a target tread pattern can be added to the collection of tire patterns used in creating the predictive equation F(q) in order to update the predictive equation.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of designing a tread pattern for a target tire, comprising:
creating a predictive equation for tire tread spacing from values of scalable parameters related to footprints of a collection of tires; and
selecting the tread pattern for the target tire based on an evaluation of the tread pattern determined by applying the predictive equation to the tread pattern for the target tire.

2. The method of claim 1, further comprising determining the values of the scalable parameters by substantially minimizing an objective function related to the collection of tires.

3. The method of claim 2, wherein the objective function is based on differences between calculated groove wander based on the footprints of the collection of tires and measured groove wander obtained by measurement of the collection of tires in use.

4. The method of claim 3, wherein the calculated groove wander is further based on a road weighting function representative of a severity of impact of a groove spacing on groove wander.

5. The method of claim 3, wherein the calculated groove wander is based on a multiple road groove response determined from the footprint.

6. The method of claim 5, wherein the multiple road groove response relates a tire lateral force responsive to a groove spacing in a road section.

7. The method of claim 1, wherein the scalable parameters include at least one of: incremental displacements of tire tread edges, filtering limits to tire tread pattern, a regression offset, and at least one value of a road weighting function.

8. A system for designing a tread pattern for a tire, comprising:
a device configured to obtain a footprint of the tire; and
a processor configured to:
create a predictive equation from values of scalable parameters related to footprints of a collection of tires;
evaluate a target tread pattern by applying the predictive equation to the target tread pattern; and
select the target tread pattern for the target tire based on the evaluation.

9. The system of claim 8, wherein the processor is further configured to determine the values of the scalable parameters by substantially minimizing an objective function related to a collection of tires.

10. The system of claim 9, wherein the objective function is based on differences between calculated groove wander based on the footprints of the collection of tires and measured groove wander obtained by measurement of the collection of tires in use.

11. The system of claim 10, wherein the calculated groove wander is further based on a road weighting function representative of a severity of impact of a groove spacing on groove wander.

12. The system of claim 10, wherein the calculated groove wander is based on a multiple road groove response determined from the footprint.

13. The system of claim 12, wherein the multiple road groove response relates a tire lateral force responsive to a groove spacing in a road section.

14. The system of claim 8, wherein the scalable parameters include at least one of: incremental displacements of tire tread edges, filtering limits to tire tread pattern, a regression offset, and at least one value of a road weighting function.

15. A computer-program product for designing a tread of a tire, the computer program product comprising a computer readable storage medium, the computer readable storage medium comprising computer executable instructions, wherein the computer readable storage medium comprises instructions to:
create a predictive equation from values of scalable parameters related to footprints of a collection of tires;
evaluate a target tread pattern by applying the predictive equation to the target tread pattern; and
select the target tread pattern for the target tire based on the evaluation.

16. The computer-program product of claim 15, further comprising instructions to determine the values of the scalable parameters by substantially minimizing an objective function related to a collection of tires.

17. The computer-program product of claim 16, wherein the objective function is based on differences between calculated groove wander based on the footprints of the collection of tires and measured groove wander obtained by measurement of the collection of tires in use.

18. The computer-program product of claim 17, wherein the calculated groove wander is based on a multiple road groove response that relates a tire lateral force responsive to a groove spacing in a road section.

19. The computer-program product of claim 15, wherein the scalable parameters include at least one of: incremental displacements of tire tread edges, filtering limits to tire tread pattern, a regression offset, and at least one value of a road weighting function.
